(19) United States
(12) Patent Application Publication
(10) Pub. No.: US 2010/0052305 A1
(43) Pub. Date: Mar. 4, 2010

(54) HOLLOWBACK BOOK AND BACKLINING STICKING APPARATUS

(75) Inventor: Kazuo SHIBUYA, Nagano (JP)

Correspondence Address: GREENBLUM & BERNSTEIN, P.L.C., 1950 ROLAND CLARKE PLACE, RESTON, VA, 20191, US

(73) Assignee: SHIBUYA BUNSENKAKU CO., LTD., Nagano (JP)

(21) Appl. No.: 12/427,131

(22) Filed: Apr. 21, 2009

(30) Foreign Application Priority Data
Aug. 28, 2008 (JP) 2008-219514

(51) Int. Cl. B42D 3/00; B42C 9/00

(52) U.S. Cl. 281/29; 412/37

(57) ABSTRACT

A hollowback book includes: a content constructed by bonding plural leaves into a single body at a spine part; a cover that surrounds the content; and a backlining that is formed in a flattened tube, is disposed between the spine part and the cover, and connects the content and the cover due to an outer surface of a content-side portion being bonded to the spine part and an outer surface of a cover-side portion being bonded to the cover. An IC tag is attached to an inner surface of the cover-side portion of the backlining.

### BACKGROUND OF THE INVENTION

1. Field of the Invention

The present invention relates to a hollowback book to which an IC tag is attached, and to a backlining sticking apparatus used when manufacturing such hollowback book.

2. Description of the Related Art

One example of a book to which an IC tag has been attached is disclosed in Patent Document 1 (Japanese Laid-Open Patent Publication No. 2002-326474: see Page 3 and FIG. 3). This book is a perfect-bound book and includes a cover and collated pages composed of printed pages that have been collated. An IC tag, which is capable of recording and reading out required information, and a thermal insulator are stuck onto an inside of a spine portion of the cover. The book is constructed with the inner surface of the spine portion of the cover and the surface of the thermal insulator bonded to the spine of the collated pages by hot melt adhesive so that the cover is wrapped around the collated pages. With this book, since the IC tag is protected by the thermal insulator, damage to the IC tag due to the heat of the hot melt adhesive is avoided.

### SUMMARY OF THE INVENTION

However, by carrying out a detailed investigation of the book described above, the present inventor found the following problem with such book. Although there is demand to attach IC tags to other types of book aside from the perfect-bound book described above, specifically, to a hollowback book (i.e., a book constructed with a backlining (or “gutter”) between the cover and the content (i.e., the collated pages in the example described above), if the book construction described above is used without modification, the thermal insulator and the IC tag will be disposed between the backlining and the spine of the content. This means that both regions where the backlining is directly bonded to the spine of the content via the hot melt adhesive and regions where the thermal insulator is bonded to the spine of the content via the hot melt adhesive will be present. The present inventor found that due to the difference in how such regions are bonded, stress becomes concentrated at the boundaries between the regions, resulting in the problem that there is a tendency for detachment to occur between the hot melt adhesive and the backlining. The present inventor also found that it is possible to somewhat reduce the transmission of the heat of the hot melt adhesive using a typical backlining that differs to a dedicated thermal insulator, and conceived the idea of using the backlining attaching apparatus disclosed in Japanese Patent No. 4,146,842 that was proposed by the same inventor to attach an IC tag to a backlining in a state where the transmission of heat from the hot melt adhesive can be reduced and automatically attach such backlining to a cover.

The present invention was conceived in view of the problems described above and it is a principal object of the present invention to provide a hollowback book where an IC tag can be disposed inside the spine of the book while reducing the influence of heat from hot melt adhesive without using a special thermal insulator. It is a further object of the present invention to provide a backlining sticking apparatus that can automate an operation that sticks a backlining and an IC tag to a cover and is required during fabrication of a hollowback book.

A hollowback book according to the present invention includes: a content constructed by bonding a plurality of leaves into a single body at a spine part thereof; a cover that surrounds the content; and a backlining that is formed in a flattened tube, is disposed between the spine part and the cover, and connects the content and the cover due to an outer surface of a content-side portion thereof being bonded to the spine part and an outer surface of a cover-side portion thereof being bonded to the cover, wherein an IC tag is attached to an inner surface of the cover-side portion of the backlining.

According to this hollowback book, by attaching the IC tag to an inner surface of the cover-side portion of the backlining that is in the form of a flattened tube, it is possible to avoid a situation where hot melt adhesive directly contacts the IC tag when the spine part of the content is bonded to the outer surface of the content-side portion of the backlining using the hot melt adhesive. By doing so, it is possible to greatly reduce the frequency of problems such as damage or breakdown of the IC tag due to heat being directly transmitted from the hot melt adhesive. Also, according to the above hollowback book, since the entire outer surface of the cover-side portion of the backlining is bonded to the cover and the entire outer surface of the content-side portion is bonded to the content, unlike a construction where the IC tag is disposed via a thermal insulator between the spine part of the content and the backlining, it is possible to avoid a situation where stress becomes concentrated at certain positions. As a result, it is possible to prevent separation of the backlining and the content over the long term and thereby improve durability. In addition, according to the above hollowback book, since a thermal insulator (member that has thermal insulation function other than the backlining) is not used, it is possible to reduce the component cost and in turn the manufacturing cost.

In the above hollowback book, the backlining may be formed in the flattened tube by folding over both side portions in a width direction of a rectangular piece of paper and overlapping and bonding together end parts of both the side portions, the cover-side portion of the backlining may be constructed of both the side portions, and the IC tag may be covered by the overlapping end parts of both the side portions.

According to this construction, two layers, i.e., both side portions of the backlining will be interposed between the hot melt adhesive and the IC tag. This makes it possible to significantly reduce the transmission of heat emanating from the hot melt adhesive to the IC tag, and as a result, it is possible to significantly reduce the frequency of problems.

In the above hollowback book, a width of the backlining may be formed wider than a width of the spine part.

According to this construction, it is possible for the spine part of the cover to maintain substantially the same U-shape when viewed from above both when the hollowback book is opened and when the hollowback book is closed. Accordingly, since it is possible to avoid a situation where the IC tag, which is attached to a center region (a region attached to the spine part of the cover) of the cover-side portion of the backlining that is kept in a U-shape, becomes bent in an acute angle, it is possible to prevent problems such as damage to and breakdown of the IC tag.

A backlining sticking apparatus according to the present invention is used to stick the backlining onto the cover to fabricate any of the hollowback books described above and includes: a paper folding unit that continuously forms a strip of paper into a flattened tube of a predetermined width; a backlining cutting unit that cuts the tube-shaped paper that has been formed by the paper folding unit into a predetermined length to fabricate the backlining; an adhesive applying unit that applies adhesive with a same width as the width of the backlining onto a center part of a surface of a cover for a hollowback book which is being conveyed on a conveying route in a non-bent state; a backlining sticking unit that sticks the backlining onto the cover by bonding the cover-side portion of the backlining onto a portion of the cover where the adhesive has been applied; and an IC tag attaching unit that is disposed upstream of the paper folding unit and attaches an IC tag to a region of the strip of paper that forms an inner surface of the cover-side portion.

In this way, according to the above backlining sticking apparatus, by including the construction elements described above, it is possible to automatically fabricate backlinings in the form of flattened tubes that have the IC tags stuck onto the inner surfaces thereof (i.e., to the inner surfaces of the cover-side portions) and to automatically stick such backlinings onto the center parts of the surfaces of the covers. This means that it is possible to efficiently manufacture the covers onto which the backlinings, which internally include the IC tags, have been stuck. Accordingly, it is also possible to efficiently fabricate hollowback books where an IC tag is attached to the inner surface of a cover-side portion of the backlining.

In the above backlining sticking apparatus, the IC tag attaching unit may attach the IC tag to a center portion of the strip of paper that forms the cover-side portion of the backlining, and the paper folding unit may form the strip of paper into the flattened tube by folding over both side portions in a width direction of the strip of paper that form a content-side portion of the backlining onto the center position to which the IC tag has been attached and overlapping end parts of both the side portions so as to cover the IC tag with the end parts.

According to the above backlining sticking apparatus, it is possible to efficiently fabricate covers onto which the backlinings have been stuck with two layers, i.e., both side portions of the backlining, interposed between the IC tag and the hot melt adhesive used to bond the backlinings and the contents. Accordingly, since it is possible to significantly reduce the transmission of heat emanating from the hot melt adhesive to the IC tag using the two layers, that is, both the side portions, it is possible to efficiently fabricate hollowback books where there is a significantly reduced frequency of problems for the IC tags.

Also, in the above backlining sticking apparatus, the paper folding unit may form the strip of paper into the flattened tube with a width that is greater than a width of the spine part of the content of the hollowback book as the predetermined width.

According to the above backlining sticking apparatus, it is possible to efficiently fabricate a cover where the center portion of a cover-side portion of a backlining to which an IC tag has been attached is resistant to bending. Accordingly, it is possible to efficiently fabricate a hollowback book that can significantly prevent damage to or breakdown of the IC tag.

It should be noted that the disclosure of the present invention relates to the content of Japanese Patent Application 2008-219514 that was filed on 28 Aug. 2008, the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a perspective view of a hollowback book;

FIG. 2 is a cross-sectional view taken along a line W-W in FIG. 1;

FIG. 3 is a plan view where the hollowback book in an opened state is viewed from above;

FIG. 4 is a diagram useful in explaining (i) the relationship between the width of the backlining in a flattened state and the width of the spine part of the content and (ii) a bonding construction of the content and the cover;

FIG. 5 is a front view of a backlining sticking apparatus;

FIG. 6 is a plan view of backlining paper in a state where IC tags have been stuck thereupon;

FIG. 7 is a plan view of the backlining paper in a state where adhesive has been applied onto the surface of one portion thereof;

FIG. 8 is a plan view of the backlining paper in a state where both side portions are being gradually folded over;

FIG. 9 is a plan view of the backlining paper in a state where both side portions have been completely folded over;

FIG. 10 is a plan view of a state where a backlining has been fabricated by cutting the backlining paper shown in FIG. 9; and

FIG. 11 is a plan view of a cover that has the backlining stuck onto a center portion thereof.

### DESCRIPTION OF THE PREFERRED EMBODIMENTS

Preferred embodiments of a hollowback book and a backlining sticking apparatus used during the manufacturing of a hollowback book according to the present invention will now be described with reference to the attached drawings.

First, the construction of a hollowback book 1 will be described with reference to the drawings.

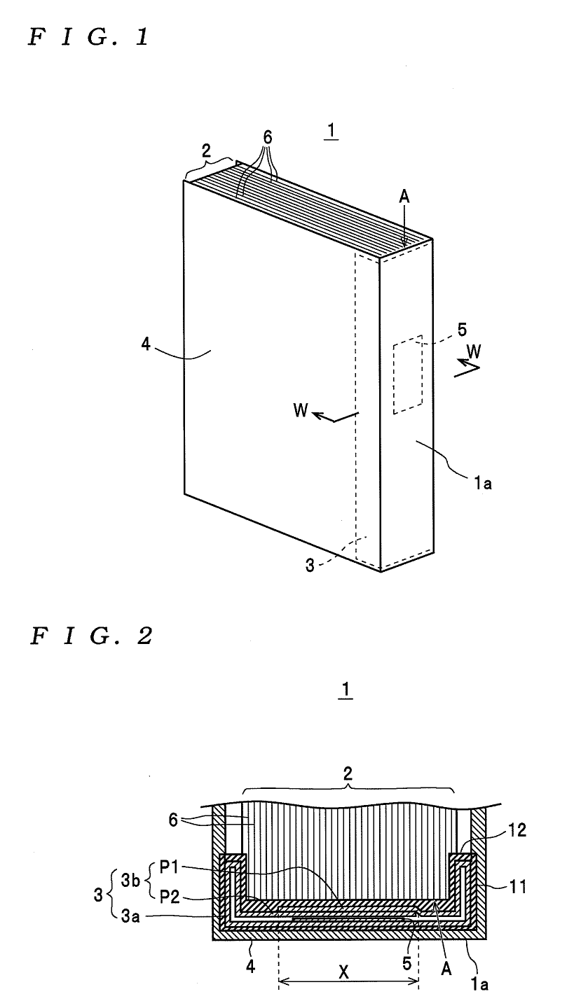

As shown in FIGS. 1 to 4, the hollowback book 1 includes a content 2, a backlining (gutter) 3, a cover 4, and an IC tag 5, is constructed as a softcover book, and has the IC tag 5 disposed inside a spine 1a of the hollowback book 1. As shown in FIG. 1, the content 2 is constructed by combining a plurality of leaves 6 and a pair of endpapers (not shown) that are disposed at both ends of the leaves 6 into a single body at a spine part A using an adhesive (for example, hot melt adhesive).

As shown in FIGS. 2 and 4, the backlining 3 is formed in the shape of a flattened tube using a strong paper material such as craft paper, backlining cloth, or Japanese paper. Also, as shown in FIG. 4, the width L1 of the backlining 3 in the flattened state is set so as to be greater than the width L2 of the spine part A of the content 2. The backlining 3 is disposed between the spine part A of the content 2 and a center portion of an inner surface of the cover 4. By bonding an outer surface of a cover-side portion 3a, which is located on the cover 4-side of the backlining 3, onto the center portion of the inner surface of the cover 4 using an adhesive 11 and also bonding the outer surface of a content-side portion 3b, which is located on the content 2-side of the backlining 3, to the spine part A of the content 2 and spine part A-side portions of the pair of end papers using a hot-melt adhesive (an adhesive such as a reactive hot melt adhesive) 12, the spine part A of the content 2 is attached to a corresponding portion (i.e., a center portion on the inner surface) of the cover 4.

Here, the backlining 3 is fabricated by attaching an IC tag 5 to a center portion of a rectangular piece of paper that forms the cover-side portion 3a (in more detail, to a center region in a width direction of such center portion), folding over both side portions P1, P2 in the width direction of the rectangular piece of paper that form the content-side portion 3b over the cover-side portion 3a, overlapping both end parts of the side portions P1, P2 so that the IC tag 5 is covered by such end parts and the rectangular piece of paper is formed into a flattened tube, and attaching (by bonding, for example) the overlapped end parts of the side portions P1, P2 so that the backlining 3 can stay in the tube-like state by itself. A stepped part with a height equal to the thickness of the paper is produced where the end parts of the side portions P1, P2 of the backlining 3 overlap. To prevent such stepped part from being visible in the external appearance of the book, a construction is used where the overlapped side portions P1, P2 are bonded to the content 2 as the content-side portion 3b.

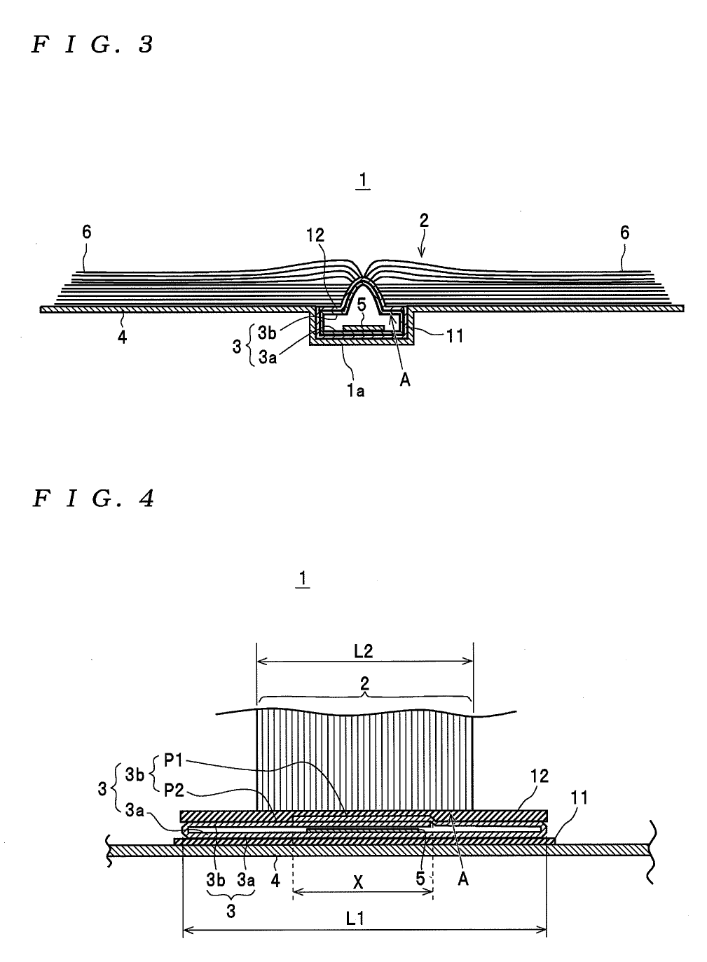

The cover 4 is used to wrap the content 2 and as one example is fabricated using special paper, such as cover paper for softcover books. The IC tag 5 (RFID: Radio Frequency IDentification) includes an IC chip and a small-scale antenna (neither is shown). As one example, as shown in FIGS. 2 to 4, the IC tag 5 is constructed of a bendable sheet (for example, a sheet that is rectangular when viewed from above), in the form of a label, and is attached to the inside of the backlining 3 that has been formed into a flattened tube. More specifically, the IC tag 5 is attached to an inner surface of a center region of the cover-side portion 3a of the backlining 3. As shown in FIG. 3, when the hollowback book 1 is opened, the content-side portion 3b becomes bent in an acute angle at the base part of the opened leaves 6 and in accordance with such bending, the content-side portion 3b also becomes bent in an acute angle. On the other hand, although the cover 4 bends at the boundaries between the cover-side portion 3a and the content-side portion 3b to become opened wide, as shown in FIG. 3, in such state the portion of the cover 4 to which the cover-side portion 3a is bonded maintains substantially the same state (that is, a U-shape) as when the hollowback book 1 is closed (the state shown in FIG. 2), and it is therefore possible to avoid a situation where the center region of the cover-side portion 3a that faces the spine part A of the content 2 greatly bends via the hot melt adhesive 12 and the content-side portion 3b positioned in the center of the U-shape. When the IC tag 5 is attached to the content-side portion 3b, there is the risk that the IC tag 5 will also bend into an acute angle together with the content-side portion 3b and become damaged, or even when such damage to the IC tag 5 does not occur, the IC tag 5 will still increase the rigidity of the content-side portion 3b, resulting in the problem of the hollowback book 1 becoming difficult to open. However, by attaching the IC tag 5 to the center region of the cover-side portion 3a of the backlining 3 that maintains a U-shape, it is possible to avoid the above problems.

Next, the fabrication process of the hollowback book 1 will be described.

In this fabrication process, first, the backlining 3 that is formed into a flattened tube and has the IC tag 5 attached to the inner surface of the cover-side portion 3a is fabricated. Next, as shown in FIG. 4, the adhesive (as examples, an emulsion or bond) 11 is applied in a straight line with the same width as the width L1 of the backlining 3 to a surface of a portion of the cover 4 that is opposite the spine part A of the content 2, or more specifically to a center portion of the inner surface of the cover 4. After this, as shown in FIG. 4, the cover-side portion 3a of the backlining 3 is stuck onto (i.e., bonded to) the portion of the cover 4 where the adhesive 11 has been applied. Next, the hot melt adhesive 12 is used to bond the spine part A of the content 2 to the outer surface of the content-side portion 3b of the backlining 3. Note that although a state where the adhesive 11 and the hot melt adhesive 12 are separated is shown in FIG. 4 for ease of understanding the present invention, the hot melt adhesive 12 is applied so that both ends thereof in the width direction (i.e., the left end and the right end in FIG. 4) actually reach the adhesive 11 and the cover 4. Finally, while folding the backlining 3 and the cover 4 as shown in FIG. 2 in accordance with the width of the spine part A of the content 2, an adhesive, not shown, is used to bond the parts of the respective endpapers of the content 2 that form the paste papers to the corresponding inner surfaces of the cover 4. By doing so, the fabrication of the hollowback book 1 that has the IC tag 5 disposed inside the spine 1a as shown in FIG. 1 is completed.

According to the hollowback book 1, by disposing the IC tag 5 inside the backlining 3 that is in the form of a flattened tube, it is possible to avoid a situation where the hot melt adhesive 12 directly contacts the IC tag 5 when the spine part A of the content 2 is bonded to the outer surface of the content-side portion 3b of the backlining 3 using the hot melt adhesive 12. By doing so, it is possible to greatly reduce the frequency of problems such as damage or breakdown of the IC tag 5 due to heat being directly transmitted from the hot melt adhesive 12. Also, according to the hollowback book 1, since the entire outer surface of the cover-side portion 3a of the backlining 3 is bonded to the cover 4 and the entire outer surface of the content-side portion 3b is bonded to the content 2, unlike the construction of the book described in the related art (that is, a construction where a material aside from the backlining 3 (i.e., the thermal insulator, for example) is disposed between the spine part A of the content 2 and the backlining 3), it is possible to avoid a situation where stress becomes concentrated at certain positions. As a result, it is possible to prevent separation of the backlining 3 and the content 2 over the long term and thereby improve durability. In addition, according to the hollowback book 1, unlike the book described in the related art, a member that has thermal insulation function (thermal insulator) other than the backlining 3 is not used, and it is therefore possible to reduce the component cost and in turn the manufacturing cost.

According to the hollowback book 1, by using a construction where the IC tag 5 is covered by the end parts of both side portions P1, P2 in the width direction of the backlining 3 (i.e., both side portions 42b, 42c in the width direction of backlining paper 42, described later), or more specifically, a construction where the width of the part where the end parts overlap is wider than the IC tag 5 and the IC tag 5 is disposed inside such region where the end parts overlap, two layers of the paper used as the backlining 3 will be interposed between the hot melt adhesive 12 and the IC tag 5. This makes it possible to significantly reduce the transmission of the heat emanating from the hot melt adhesive 12 to the IC tag 5, and as a result, it is possible to significantly reduce the frequency of problems.

Also according to the hollowback book 1, by setting the width L1 of the backlining 3 in the flattened state wider than the width L2 of the spine part A of the content 2, it is possible for the spine part of the cover 4 to maintain substantially the same U-shape when the hollowback book 1 is opened as shown in FIG. 3 as when the hollowback book 1 is closed. Accordingly, since it is possible to avoid a situation where the IC tag 5, which is attached to a center region of the cover-side portion 3a of the backlining 3 that is kept in a U-shape, becomes bent in an acute angle, it is possible to prevent problems such as damage to and breakdown of the IC tag 5.

Next, a backlining sticking apparatus 21 used during the fabrication process of the hollowback book 1 described above will be described with reference to the drawings.

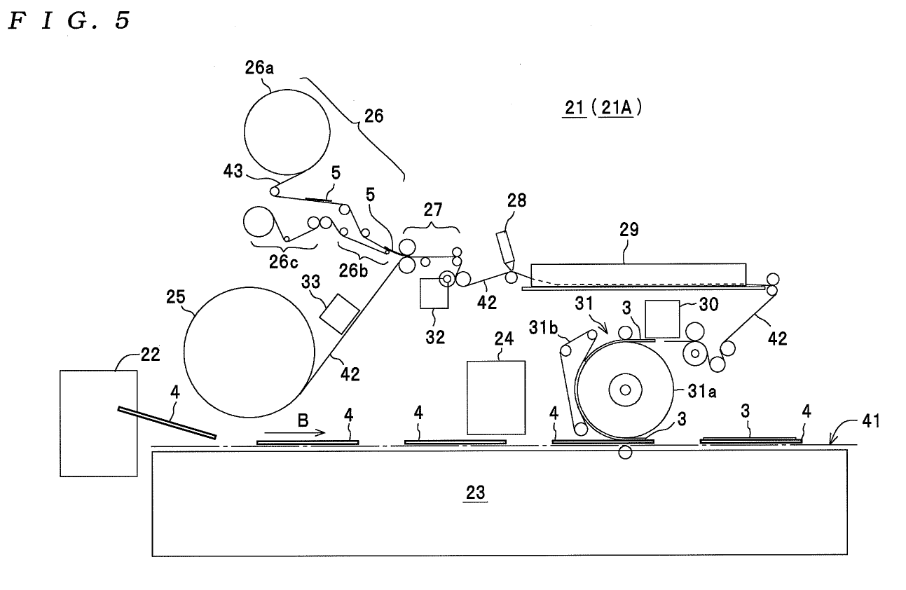

First the construction of the backlining sticking apparatus 21 will be described with reference to FIG. 5.

As shown in FIG. 5, the backlining sticking apparatus 21 includes a cover supplying unit 22, a cover conveying unit 23, a first adhesive applying unit 24, a backlining paper stocking unit 25, an IC tag supplying unit 26, an IC tag attaching unit 27, a second adhesive applying unit 28, a paper folding unit (backlining forming unit) 29, a backlining cutting unit 30, a backlining sticking unit 31, and a driving source (not shown) that couples and drives the above construction elements. The backlining sticking apparatus 21 is constructed so that the operation that sticks IC tags 5 onto the backlining paper, the fabrication of backlinings 3, and the sticking of the fabricated backlinings 3 onto the covers 4 can be automated. Also, although in the present embodiment the backlining sticking apparatus 21 includes a width adjusting unit 32 that cuts the width of the backlining paper 42 that has IC tags 5 stuck thereupon into suitable widths for the size of the cover 4 as will be described later, it should be obvious that when backlining paper 42 of a suitable width is stocked in the backlining paper stocking unit 25, it is possible to use a construction where the width adjusting unit 32 is omitted.

As shown in FIG. 5, the cover supplying unit 22 is disposed at a position furthest upstream on a conveying route 41 (shown by the dot-dash line in FIG. 5) of covers 4 and supplies the covers 4 that are yet to be folded at intervals of a fixed time to the upstream side of the conveying route 41. The cover conveying unit 23 continuously conveys the covers 4 that have been supplied to the upstream side of the conveying route 41 by the cover supplying unit 22 downstream along the conveying direction B. By doing so, the covers 4 are continuously conveyed downstream in a state with the covers 4 having been aligned at predetermined intervals on the conveying route 41. The first adhesive applying unit 24 is disposed upstream of the backlining sticking unit 31 on the conveying route 41 and applies the adhesive 11 (see FIG. 4) in a straight line with an equal application width to the width L1 of the backlining 3 onto a center part of the surface of each cover 4 conveyed on the conveying route 41.

As shown in FIG. 5, the backlining paper stocking unit 25 is constructed of a drum around which the backlining paper 42 is wound. The IC tag supplying unit 26 includes a tape reel 26a around which is wound a tape 43 to which the IC tags 5 have been attached at fixed intervals, a separating mechanism 26b that separates the attached IC tags 5 from the tape 43 by bending the tape 43 into an acute angle, and a winding-on mechanism 26c that winds on the tape 43 from which the IC tags 5 have been separated. The IC tag supplying unit 26 supplies the separated IC tags 5 to the IC tag attaching unit 27. Note that in FIG. 5, the IC tags 5 are depicted only at positions required to explain the invention.

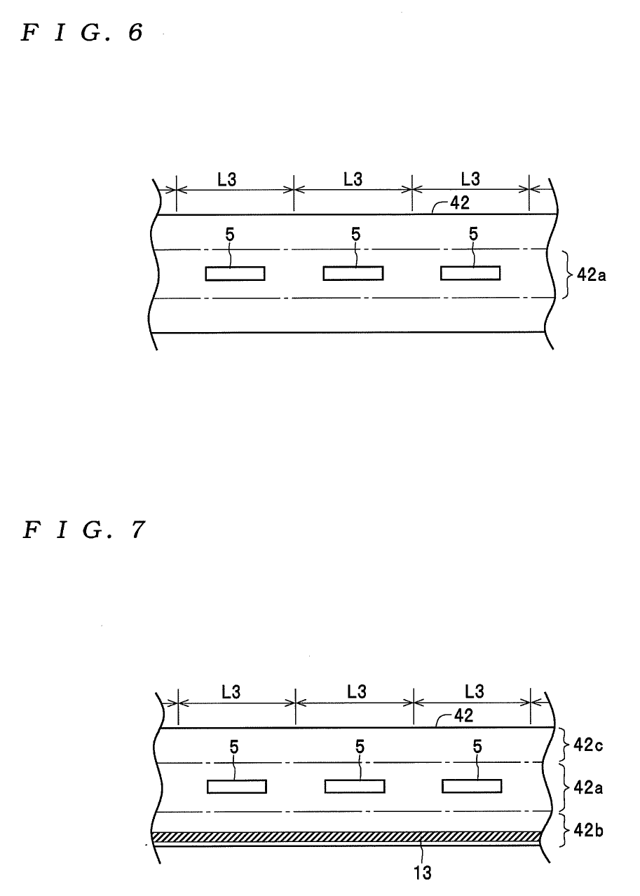

The IC tag attaching unit 27 includes a plurality of rollers and pulls out the backlining paper 42 from the backlining paper stocking unit 25 and simultaneously receives the IC tags 5 from the IC tag supplying unit 26. As shown in FIG. 6, the IC tag attaching unit 27 attaches (in the present embodiment, sticks on) the received IC tags 5 to a center portion (i.e., the region between the two dot-dash lines in FIG. 6) 42a in the width direction (the up-down direction in FIG. 6) of the backlining paper 42 at predetermined intervals L3 (i.e., a pitch equal to the length of the backlining 3) and discharges the backlining paper 42. As shown in FIG. 7, the second adhesive applying unit 28 applies an adhesive 13 onto the surface of a first portion 42b out of the side portions 42b, 42c in the width direction of the backlining paper 42 that will be bent and overlapped (i.e., onto the end part that will be folded over onto the second side portion 42c).

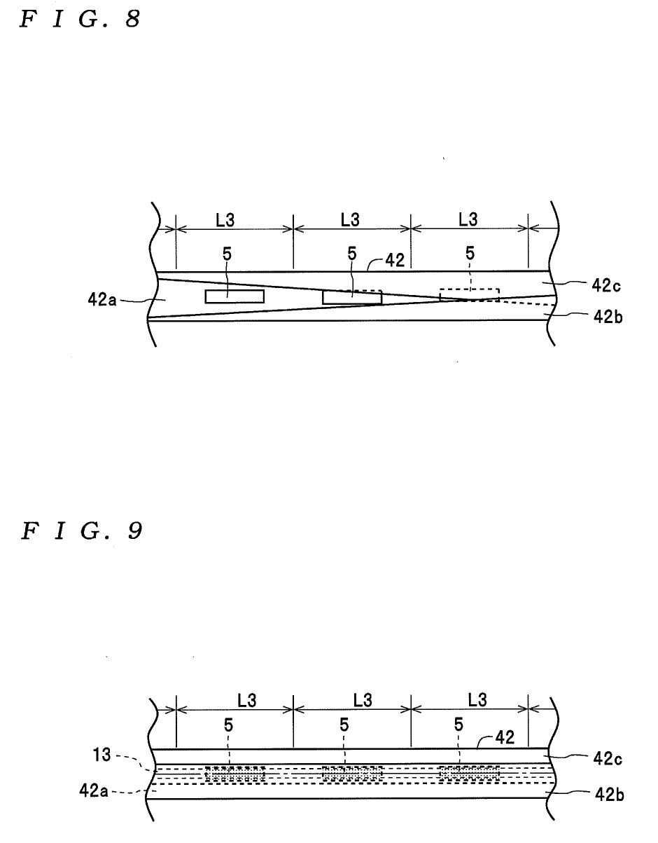

The paper folding unit 29 includes a well-known mechanism (for example, the mechanism disclosed in Japanese Patent No. 4,146,842) and, as shown in FIG. 8, functions so as to bend the second side portion 42c of the backlining paper 42 onto the center portion 42a and to then bend the first side portion 42b onto the second side portion 42c. By doing so, as shown in FIG. 9, the end parts of the first side portion 42b and the second side portion 42c that overlap one another are bonded together by the adhesive 13, thereby forming the backlining paper 42 into a flattened tube where the IC tags 5 that have been stuck onto the center portion 42a are surrounded by the backlining paper 42. Also, as one example, the paper folding unit 29 folds the backlining paper 42 so that the width of the backlining paper 42 (which is also the width L1 of the backlining 3) is wider than the width L2 of the spine part A of the content 2.

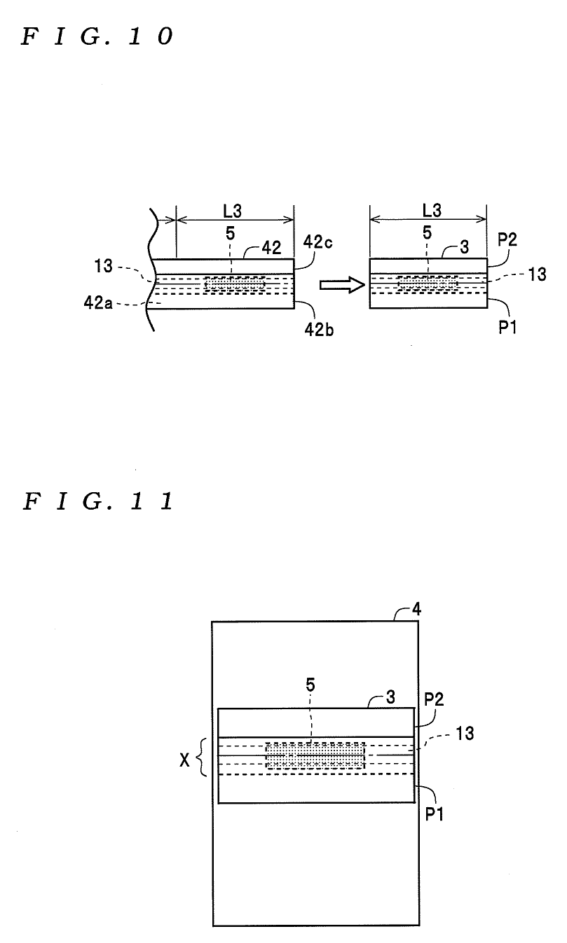

The backlining cutting unit 30 includes a cutter, not shown, and continuously fabricates backlinings 3 by cutting the backlining paper 42 in the form of a flattened tube that has been conveyed via a plurality of rollers as shown in FIG. 5 into predetermined lengths as shown in FIG. 10 (more specifically, although there are no particular limits, as examples such length may be equal to the height of the hollowback book 1 or slightly shorter). The backlining cutting unit 30 supplies the fabricated backlinings 3 to the backlining sticking unit 31 as shown in FIG. 5. In this case, both side portions 42b, 42c of the backlining paper 42 that has been formed into a flattened tube form the side portions P1, P2 of the backlinings 3 and therefore construct the content-side portions 3b of the backlinings 3, and the center portion 42a of the backlining paper 42 constructs the cover-side portion 3a of the backlining 3.

As one example, as shown in FIG. 5 the backlining sticking unit 31 includes a suction drum 31a and a continuous belt 31b in the same way as a well-known mechanism (as one example, the backlining sticking mechanism disclosed in Japanese Patent No. 4,146,842). Each backlining 3 (more specifically, the content-side portion 3b of each backlining 3) is attached by suction to the suction drum 31a and the attached backlinings 3 are held between the continuous belt 31b and the suction drum 31a and conveyed onto the conveying route 41. By doing so, each backlining 3 is supplied onto a cover 4 so that the cover-side portion 3a comes into contact with the surface of the cover 4. As shown in FIGS. 5 and 11, by stopping the suction by the suction drum 31a and releasing the backlining 3 at a position where the backlining 3 starts to contact the surface of the cover 4 (the lowest point of the suction drum 31a), the backlining sticking unit 31 sticks the backlining 3 (more specifically, the cover-side portion 3a of the backlining 3) onto the cover 4 and sends the cover 4 downstream on the conveying route 41.

Next, the operation whereby the backlining sticking apparatus 21 sticks the backlining 3 onto the cover 4 will be described.

In the backlining sticking apparatus 21, during operation the cover supplying unit 22 supplies one cover 4 at a time to the cover conveying unit 23 and the cover conveying unit 23 conveys the covers 4 in the conveying direction B on the conveying route 41. The first adhesive applying unit 24 applies the adhesive 11 (see FIG. 4) in a straight line with the same width as the width of the backlining 3 onto a center part of the surface of each cover 4 that is being conveyed by the cover conveying unit 23.

On the other hand, the IC tag supplying unit 26 supplies the IC tags 5 to the IC tag attaching unit 27 in accordance with the timing at which the covers 4 are supplied by the cover supplying unit 22, and the IC tag attaching unit 27 pulls out the backlining paper 42 from the backlining paper stocking unit 25 and sticks the IC tags 5 supplied from the IC tag supplying unit 26 onto the center portion 42a of the backlining paper 42 at predetermined intervals L3. After this, the second adhesive applying unit 28 applies the adhesive 13 onto the surface of the first side portion 42b of the backlining paper 42. Next, the paper folding unit 29 bends the side portions 42b, 42c onto the center portion 42a to form the backlining paper 42 into a flattened tube. By doing so, the IC tags 5 stuck onto the center portion 42a become surrounded by the backlining paper 42.

After this, in accordance with the supply timing of the covers 4, the backlining cutting unit 30 cuts the backlining paper 42 that has been formed into a flattened tube into predetermined lengths L3 to fabricate the backlinings 3. After this, the backlining sticking unit 31 conveys the backlinings 3 onto the conveying route 41 and then releases the backlinings 3 so that the backlinings 3 are bonded to the covers 4. This completes the fabrication of the covers 4 (see FIG. 11) to which the backlinings 3 have been bonded. In the covers 4, the IC tags 5 have been stuck onto inner surfaces of the backlinings 3 (more specifically, the inner surfaces of the cover-side portions 3a), in other words, the IC tags 5 have been enclosed inside the backlinings 3. In this case, the IC tags 5 are covered by the end parts of both side portions P1, P2 that construct the content-side portions 3b of the backlinings 3. In other words, each IC tag 5 is positioned inside a region X where the end parts of both side portions P1, P2 overlap (see FIGS. 2, 4, and 11)

In this way, according to the backlining sticking apparatus 21, by including the construction elements described above, it is possible to fabricate backlinings 3 in the form of flattened tubes that have the IC tags 5 stuck onto the inner surfaces thereof (the inner surfaces of the cover-side portions 3a) and to automatically stick such backlinings 3 onto the center parts of the surfaces of the covers 4. This means that it is possible to efficiently manufacture the covers 4 onto which the backlinings 3, which internally include the IC tags 5, have been stuck. Accordingly, it is also possible to efficiently fabricate hollowback books 1 where the IC tag 5 is attached to the inner surface of the cover-side portion 3a of the backlining 3.

Also, according to the backlining sticking apparatus 21, the IC tag attaching unit 27 attaches the IC tags 5 to the center portion 42a of the backlining paper 42 that will form the cover-side portion 3a of each backlining 3, and the paper folding unit 29 forms the backlining paper 42 into a flattened tube by folding the side portions 42b, 42c in the width direction of the backlining paper 42 that will form the content-side portions 3b of each backlining 3 onto the center portion 42a to which the IC tags 5 have been attached and overlapping the end parts of the side portions 42b, 42c so as to cover the IC tags 5 with the end parts. This makes it possible to efficiently fabricate the covers 4 to which the backlinings 3 have been stuck with two layers, i.e., the side portions P1, P2, interposed between the IC tag 5 and the hot melt adhesive 12 used to bond the backlinings 3 and the contents 2. Accordingly, since it is possible to significantly reduce the transmission of heat emanating from the hot melt adhesive 12 to the IC tag 5 using the two layers, that is, the side portions P1, P2, it is possible to efficiently fabricate the hollowback books 1 where there is a significantly reduced frequency of problems for the IC tag 5.

Also, according to the backlining sticking apparatus 21, the paper folding unit 29 forms the backlining paper 42 into a flattened tube with a predetermined width L1 that is wider than the width of the spine part A of the content 2 of the hollowback book 1. By doing so, in the hollwback books 1 fabricated by using the covers 4 onto which the backlinings 3 have been stuck, it is possible to suppress bending of the center portion of the hollowback book 1 onto which the backlining 3 has been stuck, when the hollowback book 1 is opened. Accordingly it is possible to avoid having a large external force applied to the IC tag 5 attached to the backlining 3 when the hollowback book 1 is opened. Therefore, it is possible to efficiently fabricate a hollowback book 1 that can prevent damage to or breakdown of the IC tag 5.

Note that the present invention is not limited to the constructions described above. For example, although constructions are used for the hollowback book 1 and the backlining sticking apparatus 21 described above where it is preferable for the width L1 of the backlining 3 to be greater than the width L2 of the spine part A of the content 2, the width L1 of the backlining 3 only needs to be equal to or greater than the width L2 of the spine part A of the content 2 and although not shown, it is also possible to use constructions where the width L1 of the backlining 3 is set equal to the width L2 of the spine part A of the content 2. With a hollowback book that uses this construction, although the center portion of the cover 4 onto which the cover-side portion 3a of the backlining 3 has been stuck will bend when the content 2 is opened, such portion will not become bent into an acute angle. This means that although the external force applied to the IC tag 5 disposed on the cover-side portion 3a increases, it is possible to avoid a situation where the IC tag 5 bends and becomes damaged or breaks down. Although the hollowback book 1 has been described above with no particular limitations on the type of softcover book, it should be obvious that the present invention can be applied to softcover books bound by a perfect binding, a notch binding, a sewn temporary binding, or the like, or to a hard cover book, and for this reason, the backlining sticking apparatus 21 described above can be used to fabricate the covers of such types of book.

Also, although a construction that attaches an IC tag 5 as a complete product formed on a sheet to the backlining paper 42 has been described above, as one example it is also possible to attach the IC tags 5 to the backlining paper 42 by forming antennas using a metal such as aluminum on the surface of the backlining paper 42 by foil stamping and then mounting (bonding) IC chips at the positions where the antennas have been formed on the backlining paper 42. As shown in FIG. 5, a backlining sticking apparatus 21A that attaches the IC tags 5 in this way may be realized for example by additionally disposing a foil stamping unit 33, which forms the antennas on the surface of the backlining paper 42 that has been pulled out from the backlining paper stocking unit 25, between the IC tag supplying unit 26 and the backlining paper stocking unit 25 in the construction of the backlining sticking apparatus 21 and supplying IC chips in place of the IC tags 5 from the IC tag supplying unit 26 (i.e., replacing the IC tag supplying unit 26 with an IC chip supplying unit). By forming the antennas of the IC tags 5 in this way by foil stamping, it is possible to reduce the cost of mounting the IC tags 5 on the covers 4.

What is claimed is:

1. A hollowback book comprising:
a content constructed by bonding a plurality of leaves into a single body at a spine part thereof;
a cover that surrounds the content; and
a backlining that is formed in a flattened tube, is disposed between the spine part and the cover, and connects the content and the cover due to an outer surface of a content-side portion thereof being bonded to the spine part and an outer surface of a cover-side portion thereof being bonded to the cover,
wherein an IC tag is attached to an inner surface of the cover-side portion of the backlining.

2. The hollowback book according to claim 1,
wherein the backlining is formed in the flattened tube by folding over both side portions in a width direction of a rectangular piece of paper and overlapping and bonding together end parts of both the side portions,
the cover-side portion of the backlining is constructed of both the side portions, and
the IC tag is covered by the overlapping end parts of both the side portions.

3. The hollowback book according to claim 1,
wherein a width of the backlining is formed wider than a width of the spine part.

4. A backlining sticking apparatus for sticking the backlining onto the cover to fabricate the hollowback book according to claim 1, comprising:
a paper folding unit that continuously forms a strip of paper into a flattened tube of a predetermined width;
a backlining cutting unit that cuts the tube-shaped paper that has been formed by the paper folding unit into a predetermined length to fabricate the backlining;
an adhesive applying unit that applies adhesive with a same width as the width of the backlining onto a center part of a surface of a cover for a hollowback book which is being conveyed on a conveying route in a non-bent state;
a backlining sticking unit that sticks the backlining onto the cover by bonding the cover-side portion of the backlining onto a portion of the cover where the adhesive has been applied; and
an IC tag attaching unit that is disposed upstream of the paper folding unit and attaches an IC tag to a region of the strip of paper that forms an inner surface of the cover-side portion.

5. The backlining sticking apparatus according to claim 4,
wherein the IC tag attaching unit attaches the IC tag to a center portion of the strip of paper that forms the cover-side portion of the backlining,
and the paper folding unit forms the strip of paper into the flattened tube by folding over both side portions in a width direction of the strip of paper that form a content-side portion of the backlining onto the center position to which the IC tag has been attached and overlapping end parts of both the side portions so as to cover the IC tag with the end parts.

6. The backlining sticking apparatus according to claim 4,
wherein the paper folding unit forms the strip of paper into the flattened tube with a width that is greater than a width of the spine part of the content of the hollowback book as the predetermined width.
